(19) United States
(12) Patent Application Publication
(10) Pub. No.: US 2008/0093810 A1
(43) Pub. Date: Apr. 24, 2008

(54) Structure of lay board

(76) Inventor: Yiang-Chou Liu, Taipei (TW)

Correspondence Address: BACON & THOMAS, PLLC, 625 SLATERS LANE, FOURTH FLOOR, ALEXANDRIA, VA, 22314, US

(21) Appl. No.: 11/583,078

(22) Filed: Oct. 19, 2006

(51) Int. Cl. B25H 5/00

(52) U.S. Cl. 280/32.6

(57) ABSTRACT

The structure of lay board according to the present invention is composed of a front board, a middle board, and a rear board. Those three boards are pin-jointed by several pivots, one pad is installed on each board and several wheels are installed at the bottom such that the chassis can be easily accessed or a tool can be easily taken while maintaining or repairing a vehicle. Besides, since the lay board is foldable, not only maintenance man can sit or lay on it during maintenance or repairing, but the space for storing is saved as well. The lay board according to present invention is thus a multiple purpose appliance.

### BACKGROUND OF THE INVENTION

1) Field of the Invention

The structure of lay board according to the present invention is a work-board for maintaining or repairing chassis of a vehicle. The lay board is pin-jointed by several pivots to allow sitting or laying on, and in consequence serves as a multiple purpose appliance for maintenance and repairing.

2) Description of the Prior Art

Various vehicles need periodical maintenance or irregular repair. To maintain or repair a vehicle, a maintenance man has to stay under the chassis, and they typically use a pasteboard or a cloth as mattress, which is liable to hurt skin or clothes because of scratching. Besides, it is inconvenient for the maintenance man to get the tools. Although there exists a board with wheels, which is helpful for a maintenance man to get in or out of the space under chassis, such kind of board is inconvenient to be stored and is single purpose.

Therefore, the present inventor combined holders, bolts, wheels, and pads, such that the maintenance man can easily get in or out of the space under chassis, and conveniently get tools during maintenance or repairing. Besides, the lay board not only can be folded to serves as a chair, but the space for storing is reduced as well.

### SUMMARY OF THE INVENTION

The structure of lay board according the present invention aims to provide an appliance that not only accommodates maintenance and tool-getting, but also allows either sitting or laying on, such that the user may use the lay board for maintenance and repair more convenient and easier.

The detailed descriptions as well as the technical contents of the invention shall be given with the accompanying drawings hereunder.

### BRIEF DESCRIPTION OF THE DRAWINGS

FIG. 1 is a pictorial drawing showing structure of lay board according to the present invention.

FIG. 2 is a pictorial drawing showing folding operation of lay board according to the present invention.

FIG. 3 shows structure of front board of lay board according to the present invention.

FIG. 4 shows pad operation of front board of lay board according to the present invention.

FIG. 5A shows wheel operation of lay board according to the present invention.

FIG. 5B shows embodied status of lay board according to the present invention.

FIG. 6 shows operation of stop rod of lay board according to the present invention.

FIG. 7 is a pictorial drawing of lay board according to the present invention from another view.

### BRIEF DESCRIPTION OF THE SYMBOL USED IN DRAWINGS

Lay board 1
Front board 10
Wheel 100, 100′, 121, 121′, 120, 120′
Bolt 1001, 1001′, 1210, 1210′, 1201, 1201′, 104
Pad 101, 111, 122, 123
Bearing cover 1010
Lock hole 10100
Slide slot 10101, 10301
Holder 103, 103′
Bearing seat 1030
Axle hole 1030
Screw 10102, 10103, 10104, 10105, 10302, 10303, 10304, 10305
Ball 105
Pipe 106, 112, 126
Middle board 11
Elastic push rod 110
Stop rod 1101, 1101′
Rear board 12
Connect plate 1220
Magnetic plate 125
Stop board 1261, 1262

### DETAILED DESCRIPTION OF THE PREFERRED EMBODIMENTS

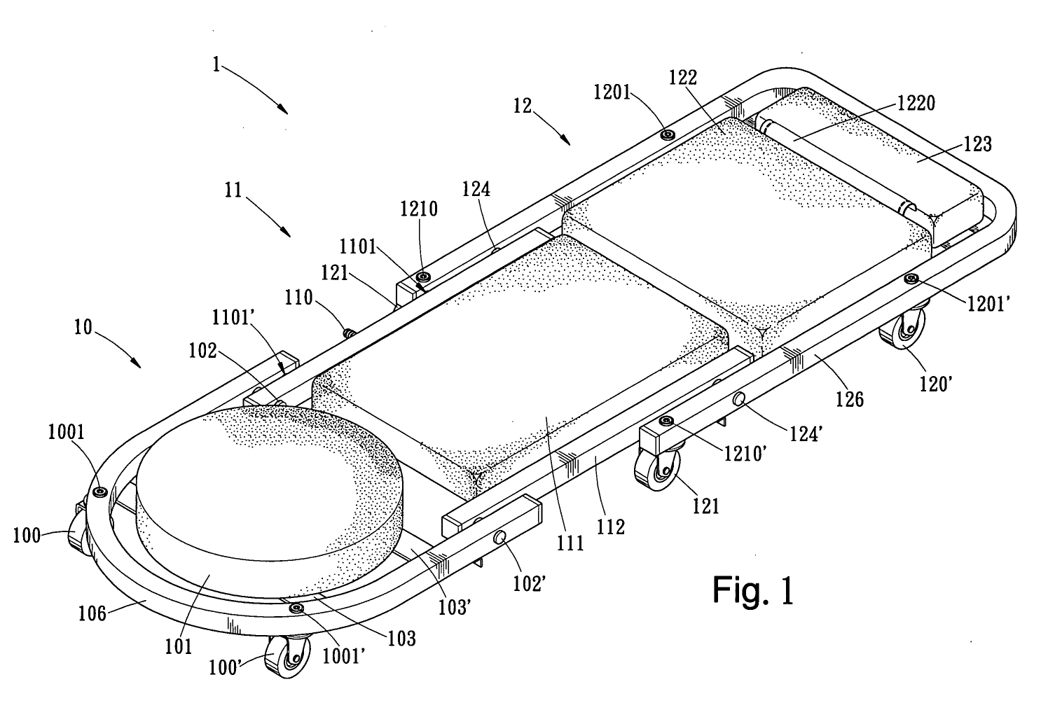

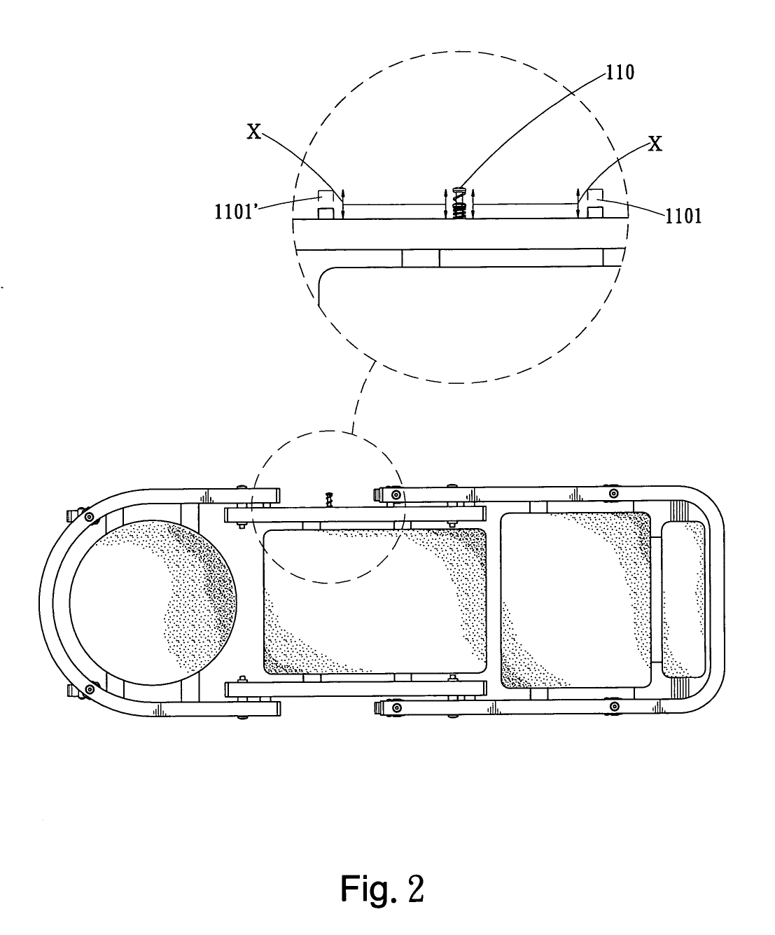

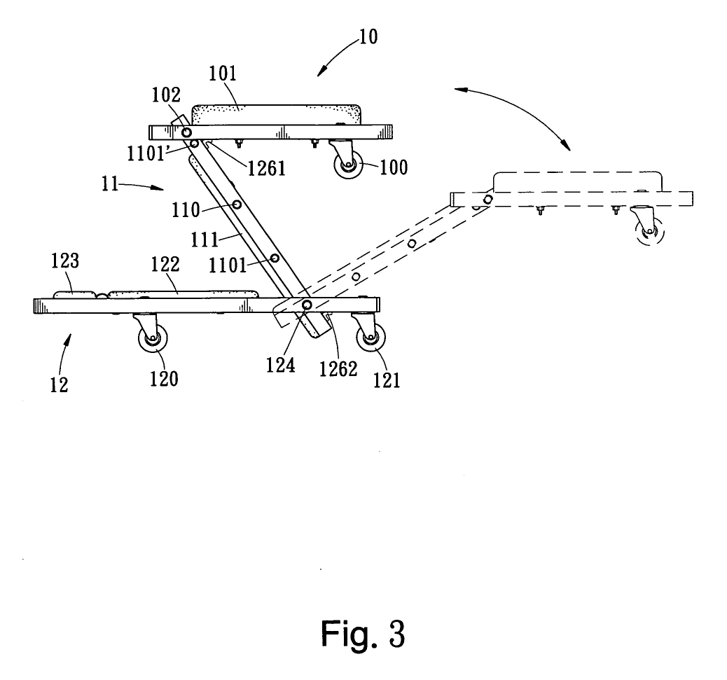

The present invention relates to a structure of lay board. Referring to FIG. 1, FIG. 2, and FIG. 3, which show that the structure of lay board mainly includes a front board 10, a middle board 11, a rear board 12, multiple bones 106, 112, 126, multiple holders 103, 103′, multiple pads 101, 111, 122, 123, and multiple wheels 100, 100′, 121, 121′, 120, 120′, which compose a lay board 1. The multiple bones 106, 112, 126 are formed into shape of round rectangle or curve by bending multiple tubes 106, 112, 126. At the bottom, multiple holders 103, 103′ and multiple tubes 106, 112, 126 are closely connected to form a concavity. The said multiple pads 101, 111, 122, 123 are round- or rectangle-shaped foam rubber, which are locked to multiple holders 103, 103′ of multiple tubes 106, 112, 126. The said multiple wheels 100, 100′, 121, 121′, 120, 120′ are wheels that can be rotated, forwards, backwards, leftwards, or rightwards, in 360 degrees. Those wheels are installed on the tubes 106, 126, to allow moving or sliding in multiple directions. Such a structure of lay board facilitates vehicle maintenance or repair performed by maintenance man.

The lay board 1 is composed of front board 10, middle board 11, and rear board 12, which are pin-jointed by pivots 102, 102′, 124, 124′, such that the lay board 1 can be bended or folded. Further, an elastic push rod 110 and stop rods 1101, 1101′ are installed at one side of middle board 11. When the lay board 1 is laid down or bended up, the elastic rod 110 is pressed to one side and the stop rods 1101, 1101′ are activated at the same time, the functions of jointing and stopping are thus enabled. Furthermore, multiple wheels 100, 100′, 121, 121′, 120, 120′ are installed at the bottom of front board 10 and rear board 12. Multiple bolts 1001, 1001′, 1210, 1210′, 1201, 1201′ lock multiple wheels 100, 100′, 121, 121′, 120, 120′ to tubes 106, 126 of front board 10 and rear board 12, such that the lay board 1 can be slid toward multiple directions.

When the lay board 1 is bended, the elastic push rod 110 installed at one side of middle board 11 is pressed to the other side, the stop rods 1101, 1101′ thus released the front board 10 and rear board 12 respectively, such that these two boards are pivoted forwards and upwards. When these two boards are bended to a position, the stop rod 1101′ touches against one end of tube 106 of front board 10, and the other end of tube 106 touches against the stop board 1261 of tube 112. Since on the other end of tube 112 a stop board 1262 is welded, which touches against the end of tube 126 when the lay board 1 is bended, the strength of supporting is accordingly good.

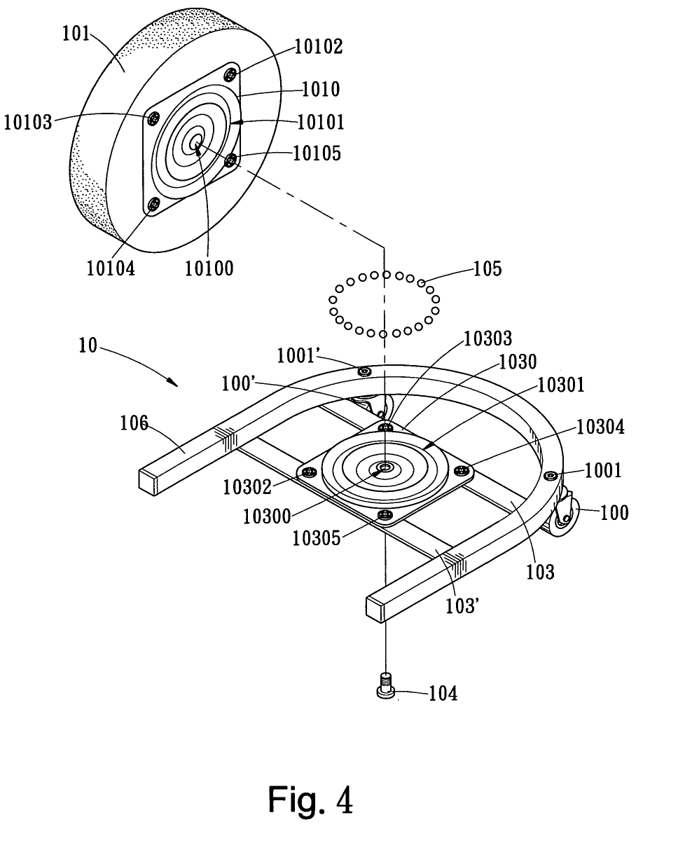

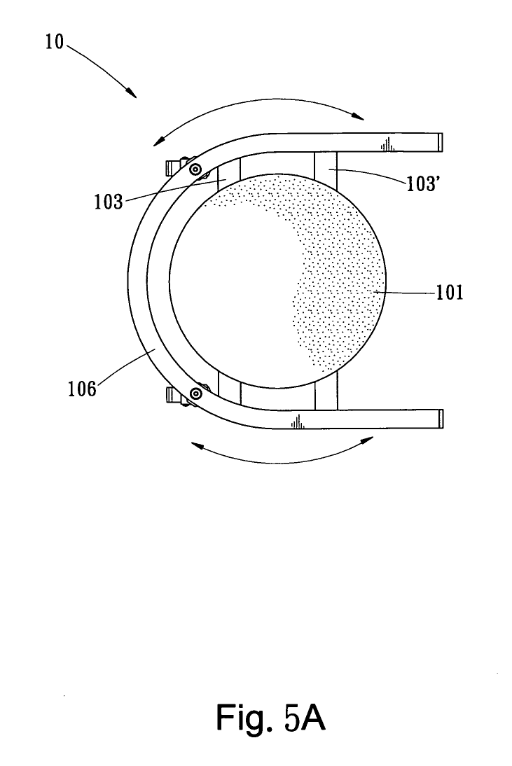

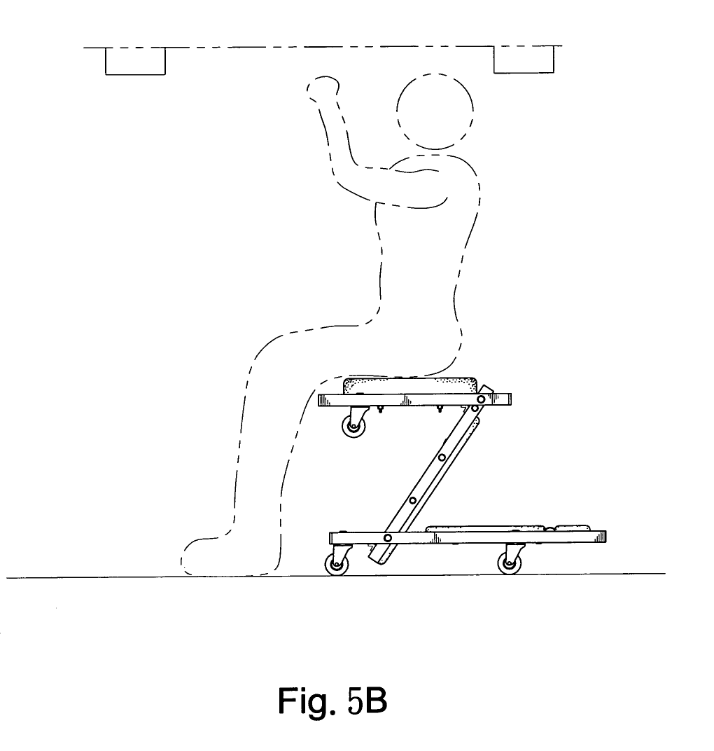

In addition, referring to FIG. 4, FIG. 5A, FIG. 5B, the front board 10 is composed of a tube 106, multiple holders 103, 103′, a bearing seat 1030, bearing cover 1010, and multiple balls 105. The bearing seat 1030 is formed by locking screws 10300, 10302, 10303, 10304 to the holders 103, 103′, while the bearing cover 1010 is formed by locking screws 10102, 10103, 103104, 10105 to the bottom of pad 101. Slide slots 10301 are respectively provided at the bearing seat 1030 and bearing cover 1010 to hold balls. An axle hole 10300 and a lock hole 10100 are respectively provided at the center of the bearing seat 1030 and bearing cover 1010, such that screw 104 passes through axle hole 10300 and locks to lock hole 10100. Multiple balls are provided in the bearing seat 1030 and bearing cover 1010 such that the pad 101 can be rotated horizontally. In consequence, the maintenance man sitting on the pad 101 may simply rotate pad 101 according to the positional requirement of repair, as shown in FIG. 5B.

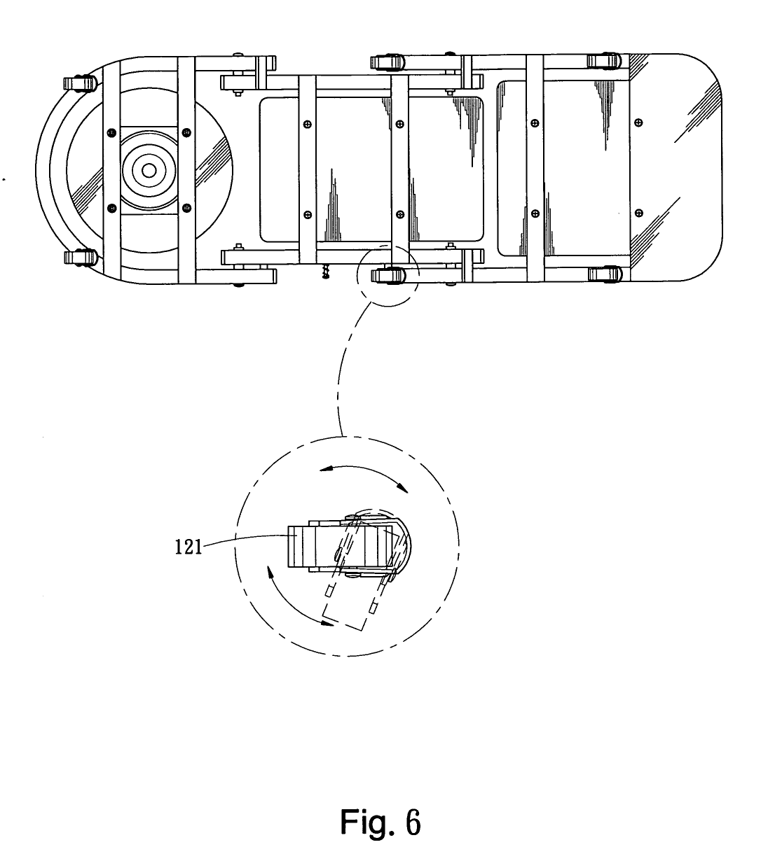

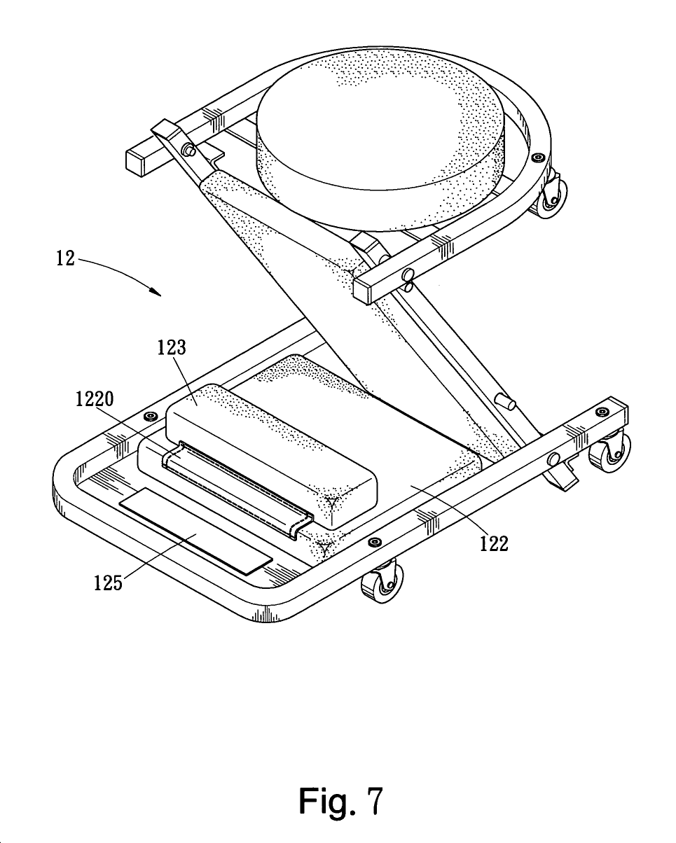

Further referring to FIG. 6 and FIG. 7, where the wheels 121 installed at the bottom of front board 10 and rear board 12 can rotate by 360 degrees, forwards, backwards, leftwards, or rightwards, such that the lay board 1 can be slid and moved toward multiple directions. A fixed pad 122 and a movable pad 123 are provided on the read board 12, and the pads 122, 123 are connected by a connect plate 1220. A magnetic plate 125 is provided, at the top of one end of rear board 12, to keep repair tools by magnetism and to facilitate taking of tools. In consequence, the users can easily apply the lay board to vehicle maintenance/repair and other purposes.

As a summary, the structure of lay board according to the present invention is a creative structure, which applies pivots 102, 102′, 124, 124′ to joint boards to enable various functions such as sitting, laying, standing, or others. The created structure of lay board is novel, advanced, and usable, which corresponds to the requirement of patent application. Although the present invention has been described and illustrated in detail, it is to be clearly that the same is by way of illustration and example only and is not to be taken by way of limitation, the scope of the present invention being limited only by the terms of the appended claims.

1. A structure of lay board includes: a front board, a middle board, a rear board, multiple tubes, multiple holders, multiple pads, multiple pivots, and multiple wheels, the boards can be folded into Z-shape, wherein multiple pads are installed on the top of boards and wheels are installed at the bottom of boards, such that the maintenance man can sit or lay on for maintenance or repair, the lay board features:
the said front, middle, and rear boards are formed by bending tubes and these boards are pivoted, and a bearing is provided at the center of front board such that the pad installed on the front board can be rotated horizontally.

2. A structure of lay board in accordance with claim 1, wherein the lay board becomes z-shape after folding.

3. A structure of lay board in accordance with claim 1, wherein the said tubes can be made of iron, aluminum, or stainless steel.

4. A structure of lay board in accordance with claim 1, wherein the pads can be shaped round or rectangle.

5. A structure of lay board in accordance with claim 1, wherein the pads can be made from leather, cloth, or synthetic leather.
